(19) United States
(12) Patent Application Publication
(10) Pub. No.: US 2024/0164388 A1
(43) Pub. Date: May 23, 2024

(54) CREPE MAKER WITH ROTATING HEATING PLATE

(71) Applicant: Nostalgia Products LLC, Green Bay, WI (US)

(72) Inventors: Gregg BOND, Beverly Hills, CA (US); Edward E. BOUGHTON, III, Ventura, CA (US)

(21) Appl. No.: 18/056,583

(22) Filed: Nov. 17, 2022

(51) Int. Cl. A21B 5/03

(52) U.S. Cl. CPC A21B 5/03

(57) ABSTRACT

An electrically powered crepe maker having a generally cylindrical base unit with an open top portion and a closed bottom portion. A heater element is disposed adjacent the top portion. A bushing is centered within the base unit connected at one end to the bottom portion of the base unit. The bushing has a second end extending to below a plane extending across the open top portion. A generally cylindrical heater plate having a top surface and a bottom surface includes a shaft extending from and centered on the bottom surface. At least one handle is connected to an outer edge of the heater plate. The shaft engages with the bushing so that the heater plate is rotatable on the base unit by using the at least one handle for stopping and starting the rotation of the heater plate.

### FIELD OF THE INVENTION

The invention is directed to the field of crepe makers.

### BACKGROUND OF THE INVENTION

Typically, crepe makes used to make crepes have a fixed heater plate. Crepe batter is placed onto the preheated heater plate and a spreader is used to spread the batter on the heater plate so that a relatively thin layer of batter is spread evenly over the heater plate. The thin layer of batter as it is heated forms into a crepe.

### SUMMARY OF THE INVENTION

The present invention is directed to an electrically powered cooking device used to make crepes. A round, completely flat heater plate is heated by a heating element under the plate. After the plate is heated to a desired temperature, batter is poured onto the plate. Unlike the prior art which requires a batter spreader to move all over the batter on the heated plate to spread the batter evenly over the plate, the plate is slowly rotated by hand, and the batter spreader is held relatively stationary so that the batter is spread as the plate rotates under the batter spreader. Although the proper technique for moving a spreader over a stationary heater plate to evenly spread the batter can be learned, the invention allows novice crepe makers to achieve good results much more quickly than would otherwise be the case. After the batter has been spread, the rotation of the heater plate is stopped and once the crepe has been cooked through, the crepe can be flipped to the other side, or removed from the heated plate depending on the recipe.

### BRIEF DESCRIPTION OF THE DRAWINGS

FIG. 1 is a perspective view of the invented crepe maker with rotating heater plate.

FIG. 2 is a perspective exploded view showing a base and the rotating heater plate which forms the invention.

FIG. 3 is a bottom plan view of the heater plate showing a pin attached to the bottom surface of the heater plate.

FIG. 4 is a top plan view of the crepe maker without the rotating heater plate.

FIG. 5A is a cross section of the crepe maker taken along the line 5A-5A of FIG. 2 with rotating heater plate removed from the base of the crepe maker.

FIG. 5B is a cross section of the crepe maker with rotating heater plate taken along line 5A-5A of FIG. 2 with rotating heater plate attached to the base of the crepe maker.

### DETAILED DESCRIPTION OF THE INVENTION

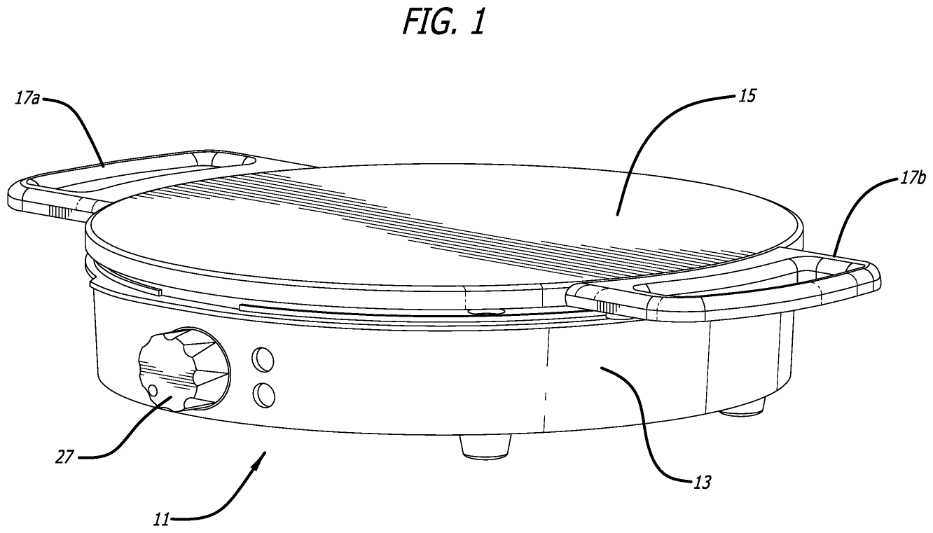

FIG. 1 shows the invented crepe maker 11 having a base 13, and a circular heater plate 15, with handles 17a and 17b.

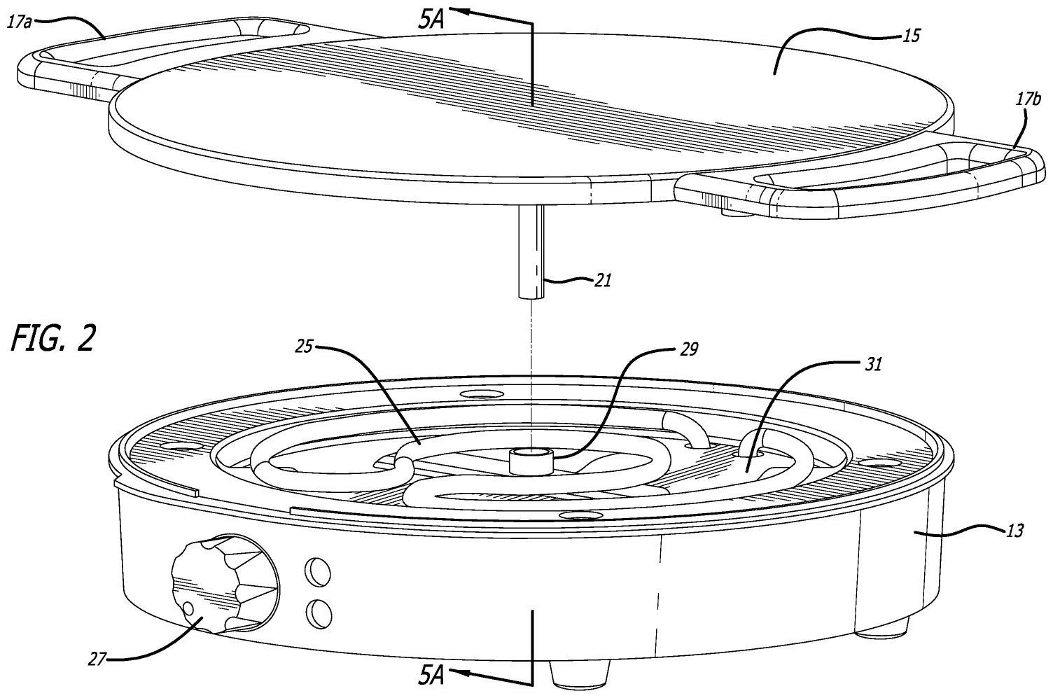

As shown in FIG. 2, the underside of heater plate 15 includes an attached shaft 21 extending perpendicular to the bottom of the heater plate, and base 13 includes a heating element 25, a control knob 27 and bushing 29 is formed as a hollow cylinder with open ends at its top and bottom sized to receive shaft 21. Bushing 29 extends through the center of base plate 31 through raised portion 33 which supports heating element 25. Not shown is an electrical connection used to supply an electrical current to the heating element, the amount of current supplied depending the position of control knob 27. The specifics of the operation of supplied current, heating element 25 and control knob 27 are well known in the art and are not important to an understanding of the invention.

Handles 17a and 17b attached to the outer circumference of heater plate 15 are used to manually rotate the heater plate while making crepes from batter added to the heater place. In an embodiment, since it is necessary to use the handles to spin the heated heater plate when making crepes, the handles are made of a material which is a poor conductor of heat and/or are attached to the heater plate in a manner which minimizes the amount of heat transferred from the heater plate to the handles. The specifics of such materials and attachment mechanisms are well known in the art and are not needed for a proper understanding of the invention.

Since the heater plate used to make crepes is circular, shaft 21 needs to be securely fastened to the bottom of the heater plate at its center. The diameter and length of the shaft should be sized so that when inserted into the top opening of bushing 29, the bushing is sized that its hollow interior provides a fit secure enough to allow the shaft and heater plate 15 to freely rotate around the base, while remaining level so that the top of the heater plate maintains itself in a level plane. In this manner, as batter is added to the heater plate, and the heater plate is rotated, the batter will spread out over the heater plate due to centrifugal forces. Although not strictly necessary, a batter spreader of the type known in the art for making crepes can be used to ensure the even spread of the batter over the heater plate. However, since the heater plate is rotating, the batter spreader can be held in a relatively stationary position, just touching the batter, as the batter passes under the spreader as the heater plate rotates to ensure a uniform thickness of the batter on the plate.

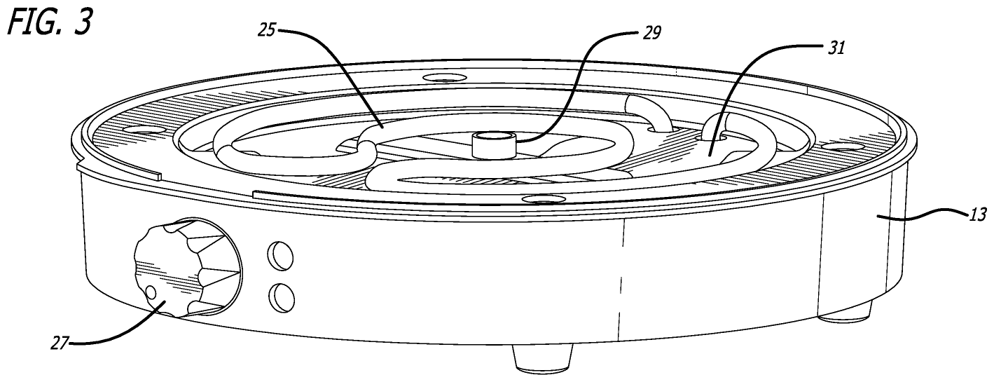

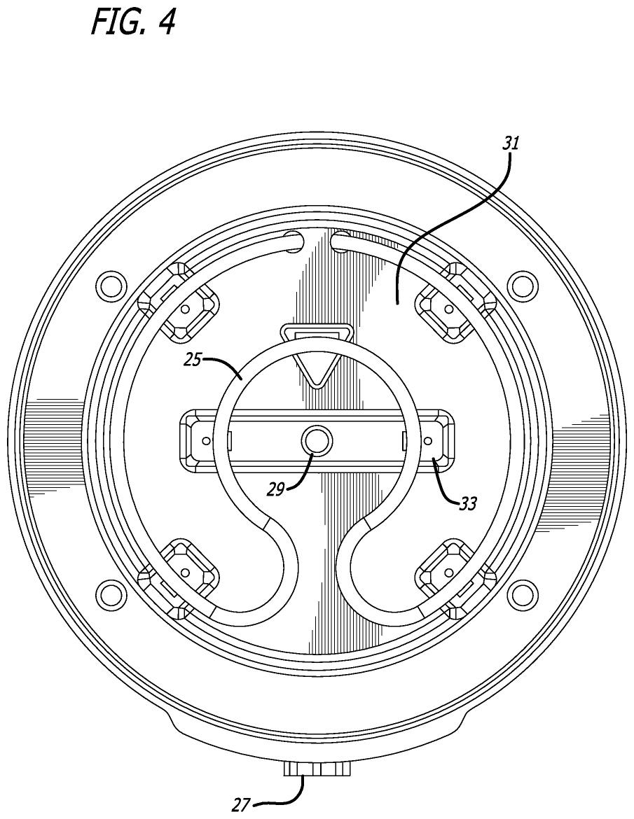

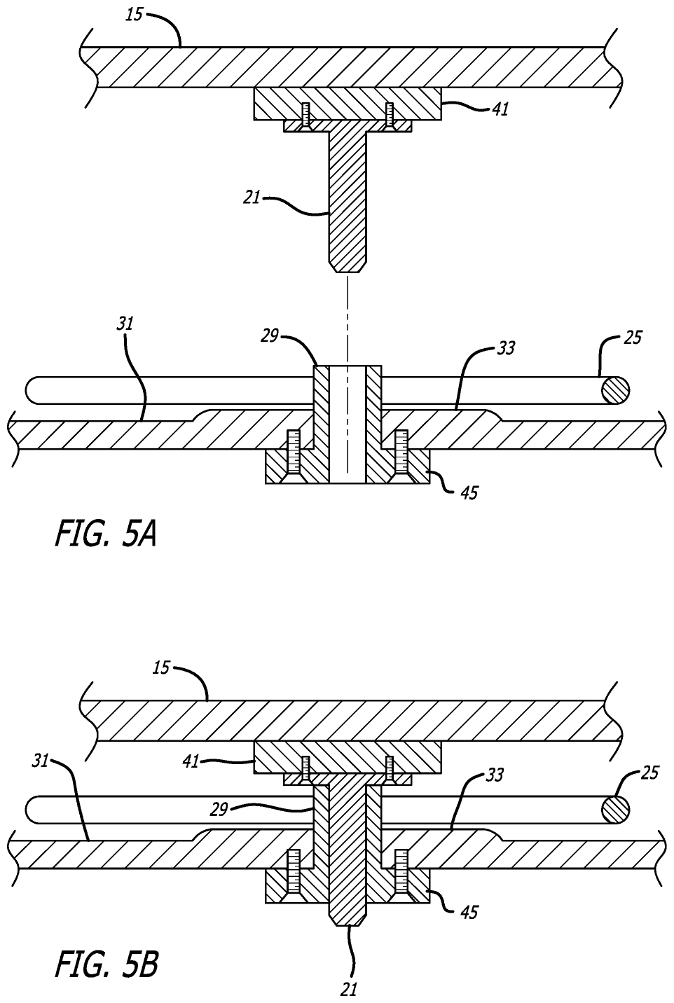

As shown in FIG. 3, in an embodiment, shaft 21 is formed as part of a heater plate 15 connected to the bottom surface of heater plate 15 by rivets, screws or other connection mechanism (see FIGS. 5A and 5B). The shaft could also be made integral with heater plate 15. However, since heater plate 15 is heated to a relatively high temperature, the manner in which shaft 15 is connected to heater plate 15 should be sufficient to withstand the heat applied by heater element 25 to heater plate 15.

For its part, bushing 29 should also be securely connected to a raised portion 33 of base plate 31 and centered so that its opening is aligned with shaft 21 when plate 15 is placed onto the base such that shaft 15 fits into the open end of bushing 29 in a mating relationship such that the plate 15 is held securely in a level position over base 13 and base plate 31, but is able to rotate by virtue of shaft 21 spinning inside bushing 29. The specifics of the secure connection of bushing 29 to base plate 31 are not important for a proper understanding of the invention, though of course the connection such be such that the bushing is fixed to the base so that it does not move as plate 15 rotates. Raised portion 33 also supports a portion of heating element 25. However, if raised portion 33 is not needed to support the heating element 25, base plate 31 can be flat at the location of raised portion 33 in which case bushing 29 would be connected to the flat surface of base plate 31. In an embodiment, shaft 21 and/or the inside of bushing 29 can be coated with a suitable material to reduce the friction between shaft 21 and the inside of bushing 29 so that heater plate 15 can be freely rotated.

Additional details of shaft 21 and bushing 29 are provided with reference to the cross-sections of shown in FIGS. 5A and 5B. Shaft 15 is shown as formed with a block 41 that connects to the bottom of heater plate 15 by screws or rivets. Alternatively, shaft 21 could be formed integral with heater plate 15. Whether integral or connected with block 41, shaft 21 must be securely connected to heater plate 15 so that it can withstand the heat applied to the heater plate and the forces created when heater plate 15 is rotating.

Bushing 29 is connected to a bottom portion of base plate 31 with a block 45 that connects to the bottom of base plate 31 by rivets or screws. Bushing 29 could also be made integral with base plate 31. Whether integral or connected with block 45, bushing 29 must be securely connected to base plate 31 so that it can withstand the heat from heater element 25 and the forces created when shaft 21 is rotating with the bushing.

Shaft 21 and bushing 29 are sized so that when shaft 21 is fully inserted into bushing 21, it preferably extends past the bottom end of bushing 29 to maximize the support provided by bushing 29 to shaft 21. The top end of bushing 29 preferably extends a distance sufficient to maximize the support provided by bushing 29 to shaft 21 such as below a plane extending across the top of base unit 13. Of course, the relative dimensions of the shaft and bushing can differ, the only requirement being that shaft 21 is able to stably rotate within bushing 29.

In operation, when electrical power is supplied to heating element 25 in a manner well known in the art, by operation of control knob 27, heat from the heating element heats heater plate 15 to a desired temperature suitable for making crepes from crepe batter. Then crepe batter is placed on the top surface of heater plate 15, preferably at or near its center. Since at the time the batter is placed on the top surface of the heating place the batter is still in a somewhat viscous liquid form, using handles 17a and 17b to rotate heater plate 15, the batter will spread over the heater plate by centrifugal force. A batter spreader may be used to ensure an even thickness of the batter spread over the entire surface of heater plate 15. Since the heater plate is rotating, the batter spreader may be held over heater plate just touching a top surface of the batter as it is being spread with little or no lateral movement.

Although the crepe maker with rotating heater plate has been described with specificity, many of specifics which are not important to an understanding of the invention are well known to persons having ordinary skill in the art and, therefore, need not be detailed herein. Similarly, although the present invention has been described in considerable detail with reference to specific embodiments thereof, other embodiments are possible. Therefore, the spirit and scope of the appended claims should not be limited to the description of the specific embodiments contained herein.

We claim:

1. An electrically powered crepe maker comprising:
a) a generally cylindrical base unit (13) having an open top portion and a closed bottom portion, including a heater element (25) disposed adjacent said top portion, a base plate (31) disposed between said heater element and said closed bottom portion and a bushing (29) centered on said base plate and connected to a bottom portion of said base plate, said bushing having one end extending through said base plate ending below a plane extending across said open top portion;
b) a generally cylindrical heater plate (15) having a top surface and a bottom surface including a shaft (21) extending from said bottom surface and centered on said bottom surface;
c) at least one handle (17a) connected to an outer edge of said heater plate,
wherein said shaft engages with said bushing so that said heater plate is rotatable on said base unit as said shaft rotates within said bushing, said at least one handle usable for stopping and starting a rotation of said heater plate.

2. The electrically powered crepe maker defined by claim 1 wherein at least one of an outer surface of said shaft and an inner surface of said bushing are coated with a material which reduces friction between mating surfaces.

3. The electrically powered crepe maker defined by claim 1 wherein said bushing extends in a direction perpendicular to said bottom portion of said base unit and said shaft extends in a direction perpendicular to said bottom surface of said heater plate such that said shaft is received by said an opening formed at said second end of said bushing, said opening extending into said bushing a distance sufficient to receive a length portion of said shaft sufficient to maintain said top surface of said heater plate in a plane parallel to said plane extending across said open top portion.

4. The electrically powered crepe maker defined by claim 1 further comprising a second handle connected to said outer edge of the heater plate.

5. The electrically powered crepe maker defined by claim 4 wherein said first handle and said second handle are connected to said outer edge of the heater plate in a symmetrical relationship.

6. The electrically powered crepe maker defined by claim 4 wherein said handles are made of material which reduces absorption of an amount of heat passed by said heater plate to said handles.
